(19) United States
(12) Patent Application Publication
(10) Pub. No.: US 2026/0124624 A1
(43) Pub. Date: May 7, 2026

(54) Centrifuge with flammable temperature control medium

(71) Applicant: Eppendorf SE, Hamburg (DE)

(72) Inventor: Alexandra BRISCH, Halle (Saale) (DE)

(73) Assignee: Eppendorf SE, Hamburg (DE)

(21) Appl. No.: 19/326,816

(22) Filed: Sep. 12, 2025

(30) Foreign Application Priority Data
Nov. 7, 2024 (DE) 10 2024 132 552.6

(51) Int. Cl. B04B 7/06; B04B 15/02

(52) U.S. Cl. CPC B04B 7/06; B04B 15/02

(57) ABSTRACT

A centrifuge (10) includes a flammable temperature-control medium. The centrifuge has a very simple design and nevertheless offers sufficient protection against ignition of the flammable temperature-control medium in the event of a crash, but also at standstill and during the course of operation. To this end, a first section (42) of the temperature-control media line (40), which is arranged in the area of potential electrical or electronic ignition sources for the flammable temperature-control medium, has no connection points (114).

### CROSS-REFERENCE TO RELATED APPLICATION

This application claims the benefit of German Patent Application DE 10 2024 132 552.6, filed on Nov. 7, 2024, the content of which is incorporated in its entirety.

### TECHNICAL FIELD

The present disclosure relates to a centrifuge comprising a flammable temperature-control medium.

### BACKGROUND

Centrifuges, in particular laboratory centrifuges, are used to separate the component parts of samples centrifuged therein by using mass inertia. In the process, increasingly high rotation speeds are used to achieve high demixing rates. Laboratory centrifuges are centrifuges with centrifuge rotors that operate at preferentially at least 3000, preferably at least 10,000, in particular at least 15,000 revolutions per minute, and are usually placed on tables. In order to be able to place them on a work table, they have in particular a form factor of less than 1 m×1 m×1 m, meaning that their installation space is restricted. In this case, the device depth is preferably restricted to 70 cm maximum.

Such centrifuges are employed in the fields of medicine, pharmacy, biology, chemistry and the like.

The samples to be centrifuged are stored in sample containers and these sample containers are driven in rotation by means of a centrifuge rotor.

Various types of centrifuge rotors, for example swing-out rotors and fixed-angle rotors, are used depending on their intended use. A common feature of most of these centrifuge rotors is that they have a rotor housing with a lower rotor part, in which there may be arranged one or multiple receptacles for sample containers or sample carriers, in which in turn sample containers can be arranged. In addition, the lower rotor part usually has a hub that can be coupled to a drive shaft driven by a centrifuge motor.

In this case, the sample containers can contain the samples directly or the sample containers have their own sample containers inserted therein that contain the sample, meaning that a plurality of samples can be centrifuged in one sample container at the same time.

It is usually provided that the samples are centrifuged at certain temperatures. For example, samples containing proteins and similar organic substances are not allowed to be overheated, meaning that the upper limit for the temperature-control of such samples is in the region of 40° C. as standard. On the other hand, certain samples are cooled as standard in the region of +4° C. (the anomaly of the water begins at 3.98° C.).

In addition to such predetermined maximum temperatures of, for example, approx. +40° C. and standard testing temperatures of, for example, 4° C., further standard testing temperatures are also provided, such as, for example, at 11° C., in order to check at this temperature whether the refrigeration system of the centrifuge is running in a controlled manner below room temperature. On the other hand, it is necessary for occupational safety reasons to prevent elements having a temperature of greater than or equal to 60° C. from touching. Reference values are specified in DIN EN 61010-1:2011-07, Table 19.

In principle, active and passive systems can be used for temperature control.

Passive systems are based on exhaust air-assisted cooling or ventilation. This air is led directly past the centrifuge rotor and thus also past the sample containers housed therein, thereby effecting temperature control. The air is sucked through openings into the centrifuge vessel and the heated air is discharged again at another point of the centrifuge vessel through further openings, wherein the suction and discharge is effected independently due to the rotation of the centrifuge rotor.

Active cooling systems have a refrigerant circuit that controls the temperature of the centrifuge container (centrifuge vessel), thereby indirectly cooling the centrifuge rotor and the sample containers housed therein. For this, the refrigerant circuit has a line section which is adjacent to the centrifuge container and is wound around the latter in one or multiple turns.

Many different media find use as refrigerant or temperature-control media. Since in principle not only cooling, i.e. heat reduction, but also a heat increase can be desired in a targeted manner during centrifugation, the present application refers to temperature control and temperature-control media. In addition to the temperature control media usually used for centrifuges, such as chlorodifluoromethane, tetrafluoroethane, pentafluoroethane or difluoromethane and carbon dioxide and many others, there are also flammable refrigerants, such as butane (R600a) or propane (R290), or also a wide variety of synthetic mixtures.

Although these flammable temperature-control media have very good heat transfer properties, they have to date not usually used for safety reasons, since the temperature-control media can escape and ignite in the event of a crash of the centrifuge rotor. In such a crash, fragments of the centrifuge rotor can act at high velocity and thus very high energy within the centrifuge, thereby also destroying the evaporator and lines which convey the temperature-control medium. The flammable temperature-control medium that flows out can easily be ignited within the explosion limits due to the energy released during the crash and to electrical or electronic components in the interior of the centrifuge or in its vicinity, which can cause very severe damage, in particular also personal injury.

In order to prevent a crash of the centrifuge rotor from causing damage outside the centrifuge, stiffening or reinforcing means have already been proposed for the interior of the centrifuge. However, these would not prevent temperature-control media from escaping, because the lines of the cooling system, which form the evaporator, run around the centrifuge container and namely, in relation to these reinforcing means, between the centrifuge rotor and the reinforcing means.

A centrifuge is already known from EP 3 727 701 A1, in which flammable temperature-control media can be used without this posing a safety risk in the case of a crash of the centrifuge rotor. This is achieved because there is a second media line in which a protective gas is conveyed, that in the event of a crash is released and prevents ignition of the flammable temperature-control medium.

EP 3 807 011 A1 discloses monitoring the centrifuge for a critical pressure change in the evaporator, after the detection of which various measures are taken to prevent ignition of the flammable temperature-control medium.

WO 2016/012596 A1 discloses separating the temperature-control media circuit into a primary circuit with the flammable temperature-control medium and a secondary circuit with a non-flammable temperature-control medium. A safety vessel is arranged around the centrifuge container and there is also a safety wall for damping and catching high-energy chips and parts that possibly form in the case of a crash. The secondary circuit has a line section wound around the centrifuge container and the primary circuit is only present on the opposite side of the safety wall in relation to the safety vessel.

Common to all of these designs is that they have a very complex construction and are therefore expensive. Moreover, they can also be prone to errors due to the technical complexity.

### SUMMARY

An object of the present disclosure is to provide an improved centrifuge comprising a flammable temperature-control medium. In particular, the centrifuge is to have a simple design and nevertheless offer sufficient protection against ignition of the flammable temperature-control medium. This protection should preferably be offered in the event of a crash, during standstill and/or during the course of operation.

This is achieved with the centrifuge as disclosed and claimed.

The inventors have discovered that this object can surprisingly be solved particularly simply if there is no connection point, in particular no solder joint, in the section of the cooling system line which contains the flammable temperature-control medium and which is situated in the area of potential electric or electronic ignition sources for the flammable temperature-control medium. Because there is no connection point, the latter cannot be subject to any ageing process, meaning that during the course of operation or at standstill no flammable temperature-control medium can get into the area of ignition sources.

Moreover, therefore, there are no points in this section of the temperature-control media line that could easily be destroyed, meaning that this section of the temperature-control media line will not be destroyed easily in the event of a crash. As a result, ignition of the flammable temperature-control medium is effectively prevented in the event of a crash. Even arcing caused by the effects of a crash cannot lead to ignition, since the temperature-control media line remains undamaged and therefore no flammable temperature-control medium can leak out.

A section of the temperature-control media line designed without connection point has no solder joint or similar connection between two areas of the section; the section is therefore designed without a joint or as one piece, whereby the section consists for example integrally of a single, preferably drawn, tube section.

Potential electrical or electronic ignition sources for the flammable temperature-control medium are those electrical or electronic elements which could cause an explosion and which are therefore neither explosion-proof nor designed to consume less than 20 W electrical power. “Explosion-proof” components are those according to the ATEX Directive of the European Union (ATEX Product Directive 2014/34/EU and the ATEX Operating Directive 1999/92/EC), or elements with a power consumption of less than 20 W. For example, it could be a power relay or the centrifuge motor. Electric circuit boards or brushless fans are, by contrast, not such potential electrical or electronic ignition sources.

The centrifuge comprises a centrifuge container for receiving a centrifuge rotor, a centrifuge motor for driving the centrifuge rotor, a cooling system with an evaporator and a compressor for temperature-controlling the centrifuge rotor, and a housing in which the centrifuge container, the centrifuge rotor and the cooling system are housed, wherein the housing comprises a housing bottom, a housing wall and a cover, wherein the cooling system has a flammable temperature-control medium which is routed in a temperature-control media line, wherein a first section of the temperature-control media line is arranged in the area of potential electrical or electronic ignition sources for the flammable temperature-control medium and wherein a second section of the temperature-control media line is not arranged in the area of potential electric or electronic ignition sources for the flammable temperature-control medium, is characterised in that the first section is designed without connection points.

In one advantageous refinement, it is provided that there is a partition wall, wherein the first section of the temperature-control media line is arranged on one side of the partition wall and the second section of the temperature-control media line is arranged on the other side of the partition wall, wherein the second section of the temperature-control media line is preferably with at least one connection point. This then prevents temperature-control medium from passing from the second section of the temperature-control media line to the first section. This prevents an explosion occurring during standstill or during regular operation the centrifuge.

One advantageous refinement provides that the partition wall separates the housing into at least two chambers, with there being a first chamber and a second chamber. As a result, the passage of temperature-control medium is even better prevented.

It is preferably provided that the first chamber surrounds the centrifuge container at least in some areas and the compressor is arranged in the second chamber and/or that the first section of the temperature-control media line is arranged in the first chamber and the second section of the temperature-control media line is arranged in the second chamber. This is therefore very effective at preventing ignition.

One advantageous refinement provides that the partition wall is equipped for a fluid-tight separation of the two chambers. As a result, the passage of temperature-control medium is even better prevented.

In one advantageous refinement, it is provided that the second chamber does not contain any elements which can generate an ignition impulse for igniting the flammable temperature-control medium. As a result, the centrifuge is extremely well protected from explosions when at standstill and during regular operation. The elements of the second chamber are preferably selected from the group consisting of compressor, injection valve and fan.

One advantageous refinement provides that the first chamber is designed to be closed except for ventilation openings. This prevents an ingress of temperature-control medium and therefore ignition of temperature-control medium in the first chamber.

One advantageous refinement provides that the first chamber is fluid-tight. This also prevents an ingress of temperature-control medium and therefore ignition of temperature-control medium in the first chamber.

One advantageous refinement provides that the first chamber can be sealed shut in a fluid-tight manner by the cover. This also prevents an ingress of temperature-control medium and therefore ignition of temperature-control medium in the first chamber.

One advantageous refinement provides that in the area of the first chamber and/or in the area of the first section of the temperature-control media line, the housing does not have any perforations for air exchange in the housing bottom. The flammable temperature-control medium is as a rule heavier than air, meaning that it accumulates above the base area of the centrifuge. Due to this design, temperature-control medium is prevented from passing through the housing bottom into the first chamber or the area of the first section of the temperature-control media line.

One advantageous refinement provides that there is a fluid-tight seal between the partition wall and the housing, said seal preferably surrounding the partition wall completely, wherein the seal is designed in particular as a lip seal or sealing strip. As a result, temperature-control medium is prevented from passing into the area of the potential electrical or electronic ignition sources.

One advantageous refinement provides that at least a feed-through through the partition wall is designed with a fluid-tight seal, wherein the seal is preferably designed as a grommet, in particular a rubber grommet, wherein the feed-through preferably comprises a feed-through for cables and/or the temperature-control media line. As a result, temperature-control medium is prevented from passing into the area of the potential electrical or electronic ignition sources.

One advantageous refinement provides that there is a safety vessel that surrounds the centrifuge container at least partially, wherein at least a first area of the temperature-control media line extends inside the safety vessel, wherein it is preferably provided that a second area of the temperature-control media line extends between safety vessel and partition wall, wherein it is provided in particular that the first area of the temperature-control media line and/or the second area of the temperature-control media line is designed without connection points. The safety vessel is usually designed such that it can absorb crash energy in the event of a crash. Due to the safety vessel, safety in the event of a crash is increased even further and ignition of the flammable temperature-control medium is prevented even more effectively. This increase in safety is also achieved by the fact that the safety vessel hinders or prevents air from circulating to the safety vessel and centrifuge container area. Moreover, the safety vessel increases the stability of the centrifuge.

Although the safety vessel can form the partition wall itself, it is preferable however if the safety vessel and the partition wall are separate elements. The safety vessel preferably surrounds the centrifuge container all the way around, whereas the partition wall preferably extends across the housing.

One advantageous refinement provides that at least one feed-through through the safety vessel is designed with a fluid-tight seal, wherein the seal is preferably designed as a grommet, in particular a rubber grommet, wherein the feed-through preferably comprises a feed-through for cables or the temperature-control media line. This makes the safety vessel particularly fluid-tight, thereby further increasing explosion protection.

One advantageous refinement provides that the partition wall comprises a material from the group: plastic and metal. The partition wall can consist, for example, only of a metal plate or plastic plate. However, this plate could also be surrounded by foam on one or on both sides. However, the partition wall could also consist of a foam to/in which a foil or similar fluid-tight material is attached or incorporated. As a result, the partition wall can be adapted to meet various requirements for example in terms of thermal insulation and/or soundproofing.

One advantageous refinement provides that the partition wall comprises a thermal insulation material, preferably a foam, wherein the thermal insulation material is preferably integrally connected to a thermal insulation material of the centrifuge container. The partition wall can then be designed to be part of the thermal insulation of the centrifuge container that is typically present, which would considerably reduce costs.

One advantageous refinement provides that the partition wall comprises a fluid-tight material which is preferably a foil, a plastic plate or a metal plate. Such a fluid-tight material would effectively prevent flammable temperature-control medium from passing into the area of the ignition sources. To this end, the partition wall does not have to be completely endowed with the fluid-tight foil; rather, the partition wall can be partially endowed with a fluid-tight foil—it would suffice, for example, if the foil were arranged in the area of connection points of the temperature-control media line.

One advantageous refinement provides that the partition wall has a drainage duct which leads away from a connection point of the temperature-control media line arranged in the partition wall to the second section of the temperature-control media line, wherein the drainage duct is preferably a line, wherein it is provided in particular that the connection point arranged in the partition wall is surrounded by a fluid-tight jacket to which the drainage duct is connected. If such a connection point were to leak, the drainage duct would prevent flammable temperature-control medium from passing into the area of the ignition sources through the partition wall because the flammable temperature-control medium would take the path with the lowest flow resistance through the drainage duct and thus be conducted away from the ignition sources to the second section of the temperature-control media line. This configuration is very advantageous, for example, if the partition wall consists of a foam.

One advantageous refinement provides that there are perforations for air exchange in the housing wall in the area of the first section of the temperature-control media line, wherein the perforations preferably have a distance from a base area of the centrifuge of at least 2 cm, preferably of at least 5 cm, in particular of at least 10 cm, preferentially of at least 14 cm. This effectively prevents temperature-control medium from passing into the area of the first section and thus possibly igniting.

One advantageous refinement provides that the housing has feet for spacing the housing bottom apart from a base area of the centrifuge, wherein the feet have a height of at least 1 cm, preferably of at least 2 cm, preferentially of at least 3 cm, in particular of at least 5 cm. This also effectively prevents temperature-control medium from passing into the area of the first section and thus possibly igniting.

One advantageous refinement provides that the centrifuge is a laboratory centrifuge.

One advantageous refinement provides that there is at least one perforation for air exchange in the housing wall both in the area of the first section of the temperature-control media line and in the area of the second section of the temperature-control media line, wherein the at least one perforation in the area of the second section are arranged closer to the base area of the centrifuge, wherein the at least a perforation in the area of the second section are preferably arranged at least 1 cm, in particular at least 2 cm, preferentially at least 5 cm, particularly preferably at least 10 cm closer to the base area of the centrifuge. This effectively prevents the temperature-control medium that leaks out of the second section from passing into the first section. Firstly because there is a height barrier, but also because the temperature-control medium that possibly leaks out through the perforation in the second section dilutes very quickly in the ambient air.

Using a fan in the area of the first section can advantageously prevent any temperature-control medium from accumulating in this area of the first section or dilute any temperature-control medium that has entered by drawing in air by suction.

Using a fan in the area of the second section makes it possible to immediately dilute any temperature-control medium that leaks out from the temperature-control media line.

The features and further advantages of the present invention will become clear hereinafter with reference to the description of preferred exemplary embodiments in conjunction with the figures.

### BRIEF DESCRIPTION OF THE DRAWINGS

FIG. 1A shows a first preferred embodiment of the centrifuge in a perspective view and three lateral views.

FIG. 1B is a left side view of the centrifuge as in FIG. 1A.

FIG. 1C is a right side view of the centrifuge as in FIG. 1A.

FIG. 1D is a rear view of the centrifuge as in FIG. 1A.

FIG. 2 shows the centrifuge according to FIG. 1A in a perspective partially sectional view without safety vessel.

FIG. 3A shows the centrifuge according to FIG. 1A in an illustration without the surrounding housing wall from a top, rear perspective.

FIG. 3B shows the centrifuge according to FIG. 1A in an illustration without the surrounding housing wall from a top, front perspective.

FIG. 4 shows the centrifuge according to FIG. 1A in a sectional representation through the safety vessel.

FIG. 5 shows the centrifuge according to FIG. 1A in a sectional representation parallel to the partition wall.

FIG. 6 shows a second preferred embodiment the centrifuge in a partially lateral sectional view.

FIG. 7 shows the centrifuge according to FIG. 6 in a plan view from above of the interior.

FIG. 8 shows a centrifuge according to the prior art in a partially lateral sectional view.

### DETAILED DESCRIPTION

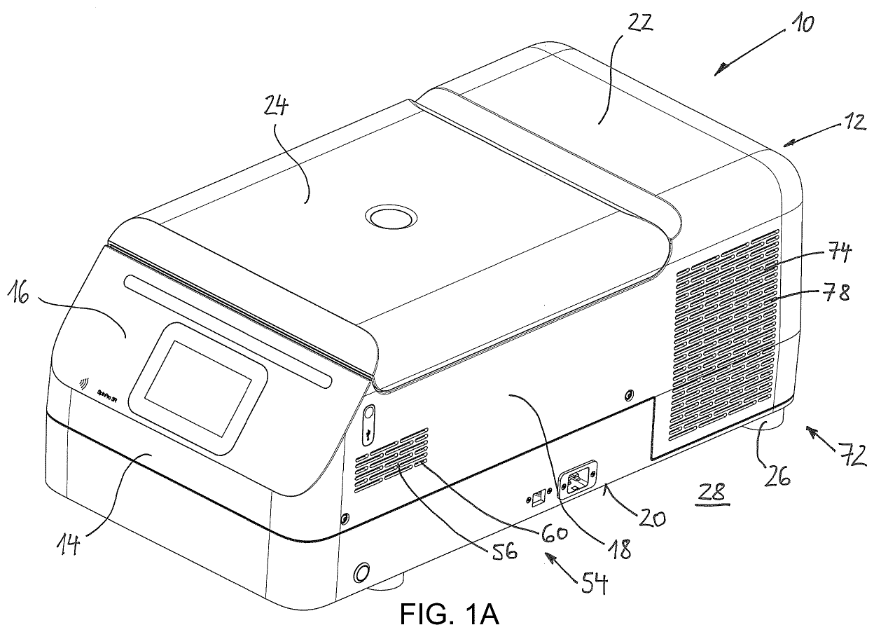

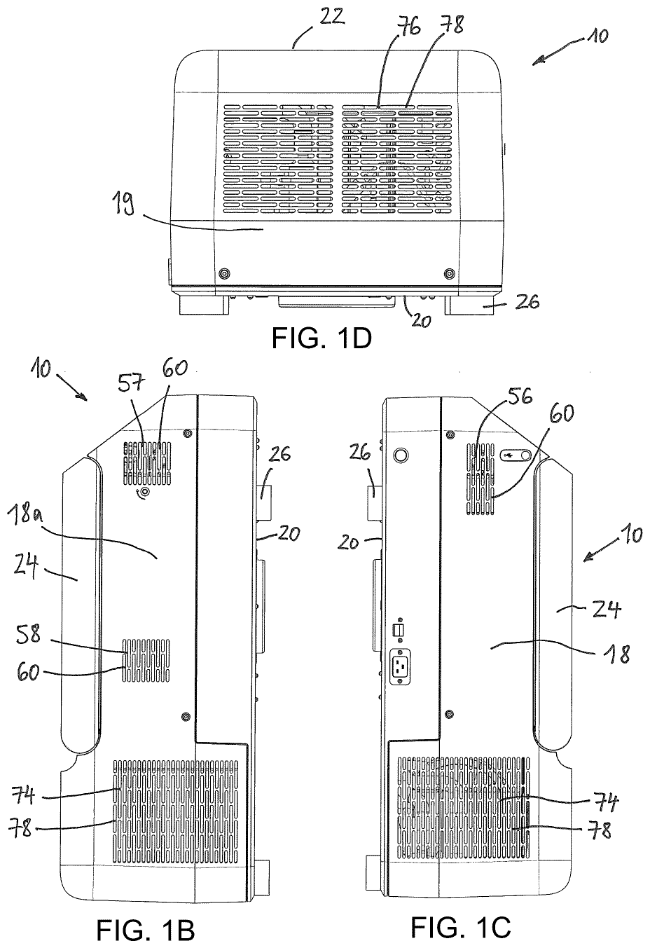

FIGS. 1A to 5 show various views of a first preferred embodiment of the centrifuge 10, which is in the form of a laboratory centrifuge.

It is apparent that the centrifuge 10 has a housing 12 with a front panel 14 with control elements 16, side walls 18, a bottom 20, a cover area 22 and a cover 24 that can be opened. Furthermore, there are feet 26, which space the housing 12 apart from a base area 28 of the centrifuge 10.

A partition wall 30 which separates the housing interior into a first chamber 32 and a second chamber 34 is arranged inside the housing 12.

Located in the first chamber 32 are the centrifuge container 36, the centrifuge motor 38 with the motor cover 38a, and a first section 40 of a temperature-control media line 42. The centrifuge motor 38 is connected to a coupling 44, into which centrifuge rotors (not shown) suitable for the centrifuge 10 can be coupled and therefore operated in order to process samples situated in the centrifuge rotor during regular operation of the centrifuge 10.

Also located in the first chamber 32 are further elements such as power relays, circuit boards, fans and the like (none of which are shown). In particular, the motor 38 and the power relay are not explosion-proof electrical or electronic components. In other words, they are components that are not manufactured in accordance with the ATEX Directive of the European Union (ATEX Product Directive 2014/34/EU and the ATEX Operating Directive 1999/92/EC), or they are elements that do not have a power consumption of less than 20 W. Therefore, these elements are potential electrical or electronic ignition sources for the flammable temperature-control medium which is routed in the temperature-control media line 40, 42.

Located in the second chamber 34 are the further essential components of the active cooling system of the centrifuge 10, namely a compressor 46, a condenser 48, a fan 50 that impacts the condenser 48 with air, and a second section 52 of the temperature-control media line 42. These components are by contrast explosion-proof electrical or electronic components.

Located on the sides 18, 18a in the section 54 of the housing 12 that surrounds the first chamber 32 are the ventilation panels 56, 57, 58, each of which has numerous perforations 60. The first section 54 of the housing 12 has no further perforations for communication with the environment, including in particular none in the bottom 20 of the housing, which is completely closed.

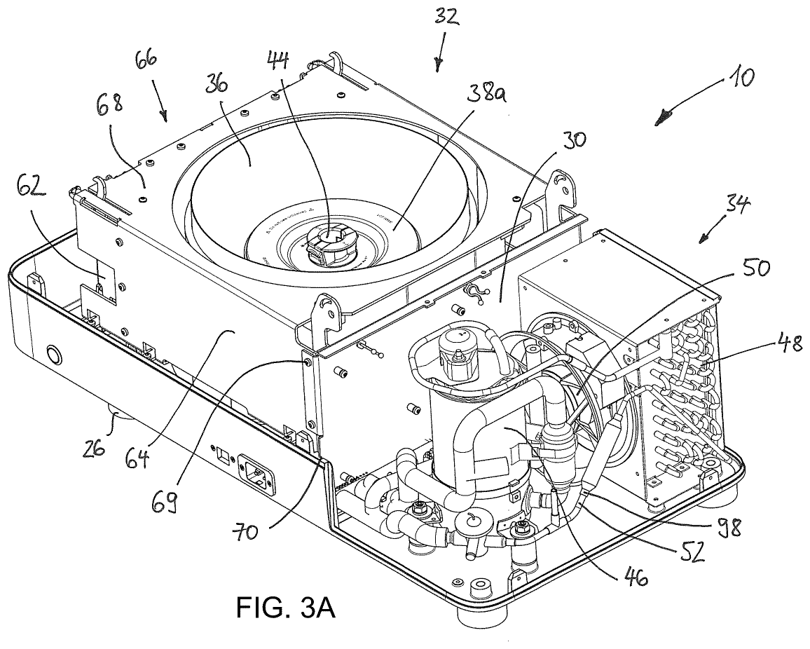

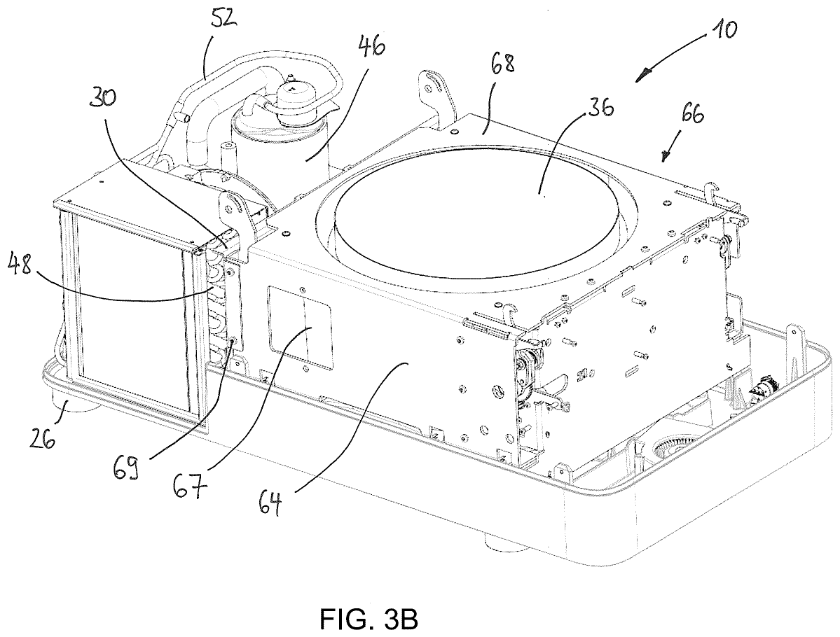

The ventilation panels 56, 57 act as air inlets and communicate with the perforation 62 arranged in the side panel 64 of a box 66 (cf. FIG. 3A). The ventilation panel 58 acts as an air outlet and communicates with the perforation 67 (cf. FIG. 3B, where the motor cover 38a and the coupling 44 are not shown). As a result, heat from inside the first chamber 32 or from inside the box 66 can be discharged to the outside by the fan located in the first chamber 32. The heat-generating components such as relays, circuit boards and in some cases also the motor 38 are arranged in or on the box 66.

In addition to the side panel 64 extending all around it, the box 66 has a cover area 68 and a bottom surface that is formed by the bottom 20 of the housing 12. The cover 24 is fastened to the cover area 68. The side panel 64 is fixedly connected to the partition wall 30 by screw fittings 69, which partition wall is thus part of the side panel 64.

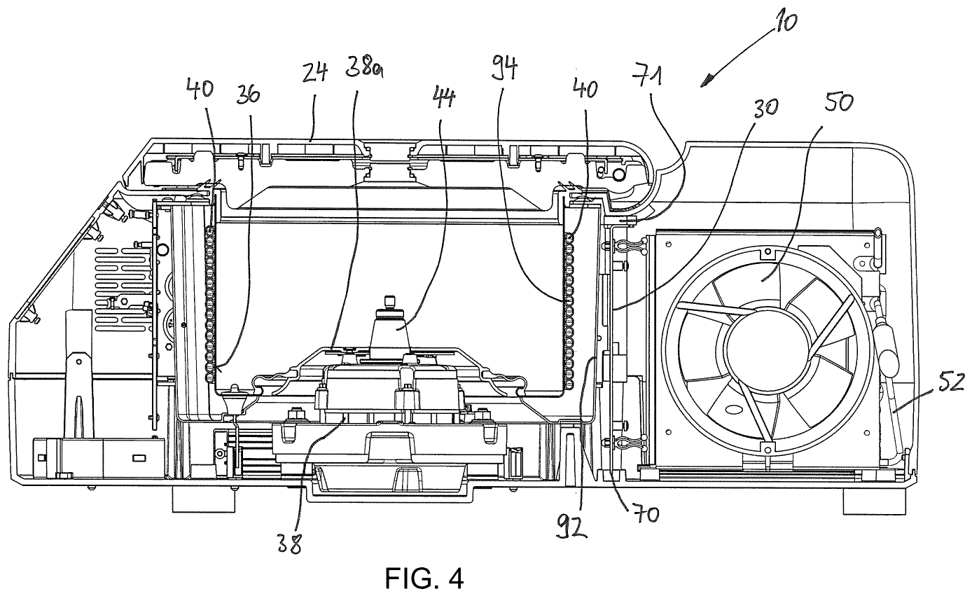

The partition wall 30 is surrounded all around by the housing 12 and in the process is guided in a lip seal 70 that partially extends around the bottom 20 and sides 18, 18a and is pressed against the housing 12 in the area of the cover 24 with the interposition of a sealing strip 71 (cf. FIG. 4).

Located on each side 18, 18a in the section 72 of the housing 12 that surrounds the second chamber 34 is a respective ventilation panel 74, and located in the rear 19 are two ventilation panels 76, each of which have numerous perforations 78.

The second section 72 of the housing 12 has no further perforations for communication with the environment, including in particular none in the bottom 20 of the housing, which is completely closed.

Air is sucked in by the fan 50 through the ventilation panel 74 in the side 18a shown in FIG. 1B, the air flows through the condenser 48 and past the compressor 46, thereby cooling the latter, and leaves the second chamber 34 through the ventilation panel 74 in the side 18 and the ventilation panel 76 in the rear 19 (cf. FIG. 1A, FIG. 1C, and FIG. 1D).

The partition wall 30 has a few perforations 80, 82. The first type of perforations 80 are circular and are each sealed shut by a lip seal 84 in which there is a thin slit 86 that is sealed shut when not in use. These perforations 80 serve to feed through cables (not shown) in a fluid-tight manner, said cables being used to actuate the components located in the second chamber and supply them with power.

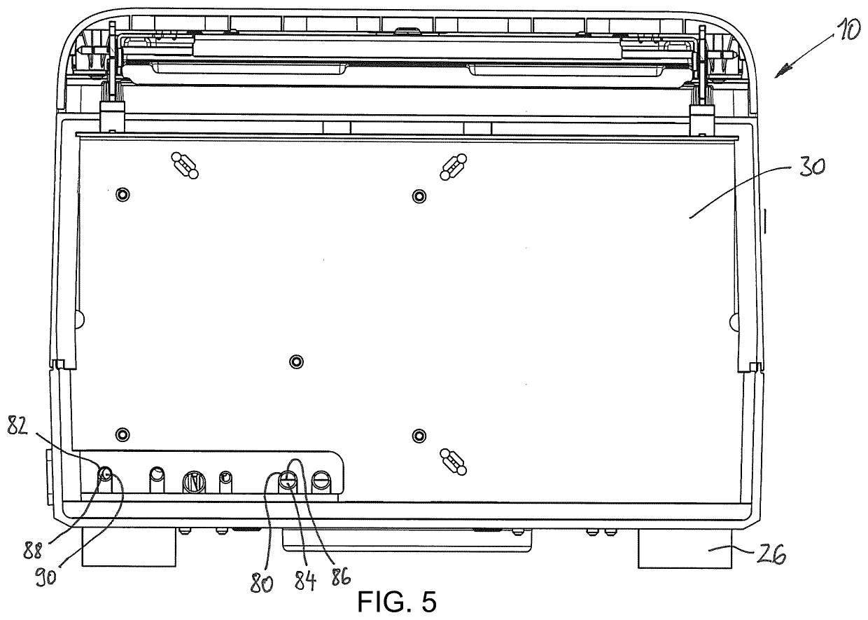

The second type of perforations 82 are circular and sealed shut by rubber grommets 88, in the centre of which there are respective openings 90 through which the temperature-control media line 42 is routed in a fluid-tight manner (cf. FIG. 5).

Due to these measures for the fluid-tight sealing of the partition wall 30, a temperature-control medium that leaks in the second chamber 34 can therefore not get through the housing 12 transversely to the partition wall 30. Therefore, it cannot pass directly from the second chamber 34 into the first chamber 32, but can at most flow out through the ventilation panels 74, 76 and into the ventilation panels 56, 57, 58 of the first chamber 32.

It can be seen in FIG. 4 that not only is the centrifuge container 36 arranged in the first chamber, but also a safety vessel 92 surrounding the centrifuge container 36, which is intended to reduce the consequences of a possible crash of the centrifuge rotor.

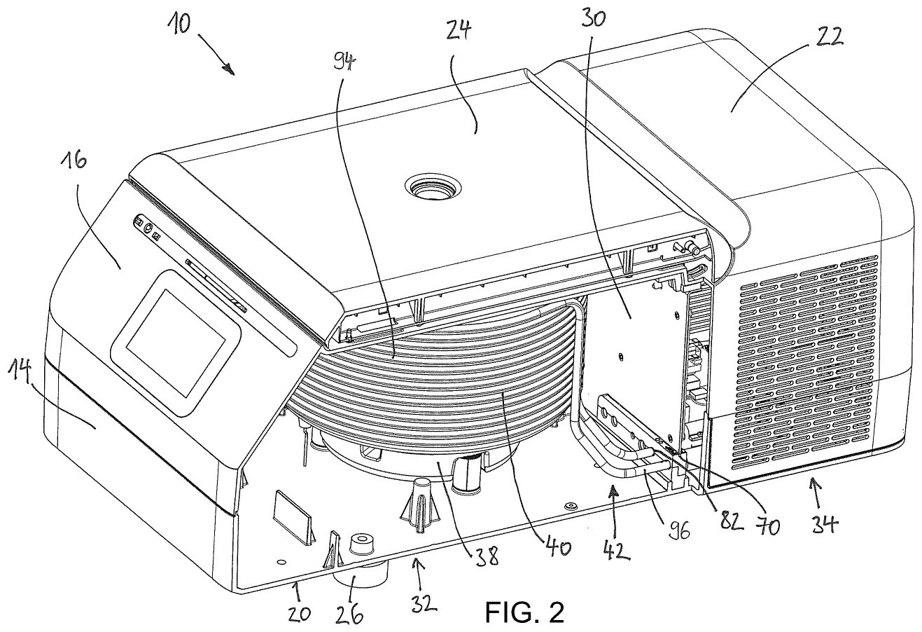

Located between the centrifuge container 36 and the safety vessel 92 is a first area 94 of the first section 40 of the temperature-control media line 42, which is guided in regions in numerous turns around the centrifuge container 36 in order to control the temperature of the latter in the usual manner. This first area 94 forms the evaporator (cf. FIG. 2).

A second area 96 of the first section 40 of the temperature-control media line 42 is arranged between the safety vessel 92 and the partition wall 30.

It is now provided that the first section 40 of the temperature-control media line 42 is designed without connection points, i.e. without joins, and therefore in one piece and in particular without solder joints. The first section 40 is therefore a continuous, integrally designed pipe, which has been drawn from a single piece of copper, for example.

It would also be possible, however, if only the first area 94 of the first section 40 of the temperature-control media line 42 or only the second area 96 of the first section 40 of the temperature-control media line 42 were designed without connection points, in which case the potential electrical or electronic ignition sources for the flammable temperature-control medium would then preferably be located in the area surrounding the first area 94 or the second area 96. Even this would achieve significant safety advantages.

In the exemplary embodiment shown, both the first area 94 and the second area 96 of the temperature-control media line 42 as well as the transition from the first area 94 to the second area 96 through the safety vessel 92 are designed to be without connection points. The transition between the first section 40 of the temperature-control media line 42 and the second section 52 of the temperature-control media line 42 through the partition wall 30 is also designed to be without connection points. By contrast, there are connection points 98 in the second section 52 itself.

The lowermost perforations 60 in the ventilation panels 56, 57, 58 are at a distance of approx. 15 cm above the bottom 20, whereas the lowermost perforations 78 in the ventilation panels 74 are at a distance of approx. 5 cm above the bottom 20 of the housing 12. The feet 26 in turn have a height of approx. 2 cm, whereby the bottom 20 itself is arranged 2 cm away from the base area 28 of the centrifuge 10. Between the lowermost perforations 78 of the ventilation panels 74 and the lowermost perforations 60 of the ventilation panels 56, 57, 58 there is thus a vertical difference in terms of arrangement of approx. 10 cm.

This configuration increases the safety of the centrifuge 10, which is designed with a flammable temperature-control medium such as propane (R290), both at standstill and during the course of operation and in the event of a crash.

This is because, neither at standstill nor during the course of operation, no flammable temperature-control medium can get into the first chamber 32, where the non-explosion-proof elements could ignite the temperature-control medium.

To be more precise, at standstill and during the course of operation of the centrifuge 10, leaks can occur in the temperature-control media line 42 only in the area of the second section 52, since only there are there joints, for example in form of solder joints in the temperature-control media line 42. These leaks can be caused by ageing, for example.

However, these leaks in the second chamber 34 are not critical, because there are no non-explosion-proof elements there or such non-explosion-proof elements do not have a power consumption of 20 W and more, meaning that leaking temperature-control medium leaking cannot ignite in the second chamber 34.

In the first chamber 32 there are no connection points in the first section 40 of the temperature-control media line 42, in the surroundings of which there are no non-explosion-proof elements or no elements with a power consumption of 20 W and more. As a result, no temperature-control medium can leak out or ignite due to leaks in the first chamber 32, either at standstill or during regular operation.

Any temperature-control medium leaking out in the second chamber 34 is forced by the fan 50 through the ventilation panels 74, 76 in the side 18 and the rear 19 into the surroundings where it is greatly diluted with ambient air.

Moreover, the flammable temperature-control medium is heavier than air, so that it sinks to the bottom 28 and disperses there.

Since the ventilation panel 74 in the side 18 reaches down approx. 10 cm lower than the ventilation panels 56, 57, 58 and a direct passage through the fluid-tight partition wall 30 is prevented, this temperature-control medium that escaped into the second chamber 34 cannot get into the first chamber 32. However, even if it gets into the first chamber, it is so diluted that no explosive mixture can be generated.

However, even if the partition wall 30 itself is not absolutely fluid-tight and thus minor amounts of temperature-control medium are able to pass through, this amount is too small to generate an ignitable mixture in the first chamber 32. (“Fluid-tight” does not mean in the context of the present disclosure therefore that the partition wall 30 in connection with the adjoining housing 12 prevents the passage of fluids under all conditions, in particular high pressures, but only that no significant amounts of temperature-control medium which could generate an ignitable mixture in the first chamber 32 can get through.

This is preferably also supported by the fact that the potential electrical or electronic ignition initiators, such as power relay, motor 38 and the like, are encased by the box 66 which further prevents any ingress of temperature-control medium. In the area between the section 54 of the housing 12 that surrounds the first chamber 32 and the box 66 there are preferably, by contrast, no such potential electrical or electronic ignition initiators.

In the event of a crash, there is also less risk of ignition, since the temperature-control media line 42 is not destroyed so quickly in the first chamber 32 due to the lack of connection points there in the area of the potential electrical or electronic ignition initiators.

Because the centrifuge 10 can be designed in the second section 52 of the temperature-control media line 42 with connection points 98, the centrifuge 10 can nevertheless be produced relatively simply and cost-effectively despite the significantly improved safety.

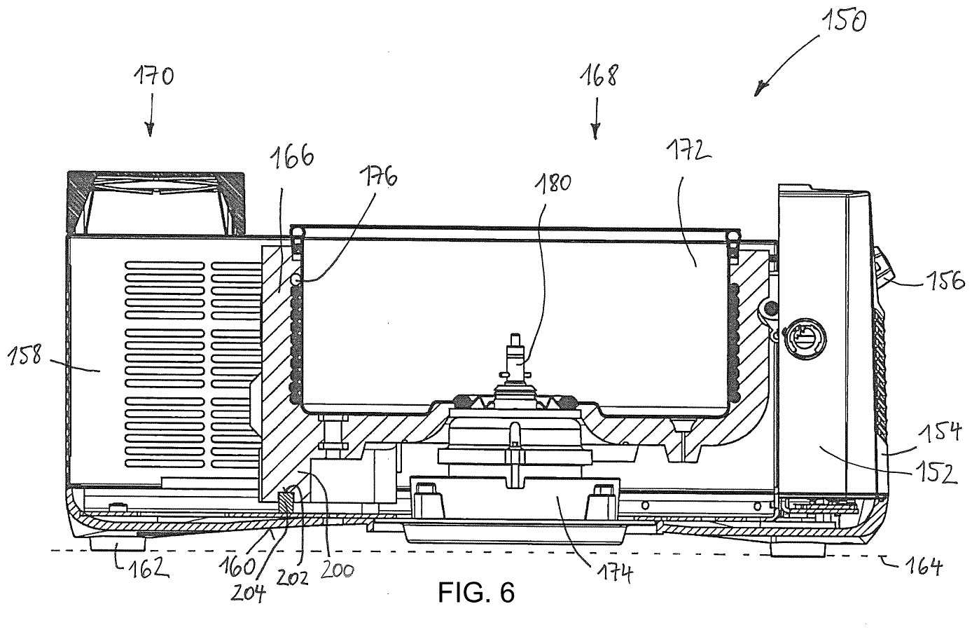

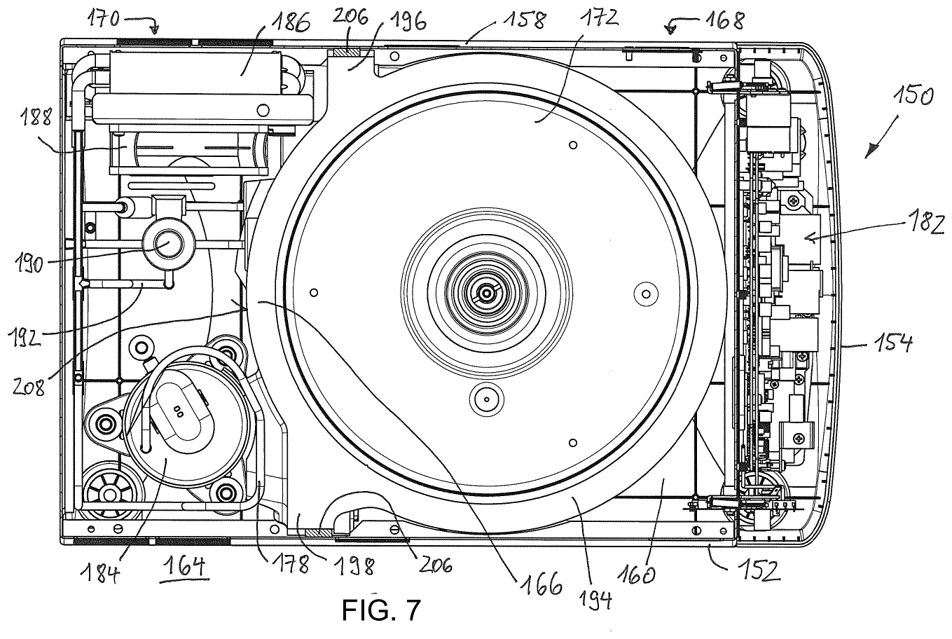

FIGS. 6 and 7 show different views of a second preferred embodiment of the centrifuge 150 which is likewise in the form of a laboratory centrifuge.

It is apparent that the centrifuge 150 has in turn a housing 152 with a front panel 154 with control elements 156, side walls 158, a bottom 160, a cover area and an openable cover (neither of which are shown). Furthermore, there are feet 162 which space the housing 152 apart from a base area 164 of the centrifuge 150.

A partition wall 166 which separates the housing interior into a first chamber 168 and a second chamber 170 is arranged in the interior of the housing 152.

Located in the first chamber 168 in turn is the centrifuge container 172, the centrifuge motor 174 and a first section 176 of a temperature-control media line 178. The centrifuge motor 174 is connected to a coupling 180 into which centrifuge rotors (not shown) suitable for the centrifuge 150 can be coupled and therefore can be operated to process samples situated in the centrifuge rotor during regular operation of the centrifuge 150.

Also located in the first chamber 168 are further electric and electronic elements, such as a power relay, controller, circuit boards and the like (collectively referenced with 182). In particular, the motor 174 and the power relay 182 are not explosion-proof electric or electronic components. That is to say, they are components that are not manufactured in accordance with the ATEX Directive of the European Union (ATEX Product Directive 2014/34/EU and the ATEX Operating Directive 1999/92/EC), or they are elements that do not have a power consumption of less than 20 W. Therefore, these elements are potential electrical or electronic ignition sources for the flammable temperature-control medium which is routed in the temperature-control media line 178.

Located in the second chamber 170 are the further essential components of the active cooling system of the centrifuge 150, namely a compressor 184, a condenser 186, a fan 188 that impacts the condenser 186 with air, an injection valve 190 and a second section 192 of the temperature-control media line 178. These components are by contrast explosion-proof electrical or electronic components.

Hereinafter, only the different elements will be discussed, while the function the remaining elements corresponds to those of the first preferred embodiment of the centrifuge 10.

In this preferred second embodiment of the centrifuge 150, the partition wall 166 is not designed as a separate element, as in the first preferred configuration of the centrifuge 10, but as an integral component part of the thermal insulation 194 that surrounds the centrifuge container 172.

To be more precise, FIG. 7 shows that the thermal insulation 194 has laterally projecting projections 196,198 which extend over the entire height of the interior of the centrifuge 150. Moreover, there is also a lower carrier 200, which extends between the two projections 196, 198 on the bottom side of the thermal insulation 194.

The carrier 200 has a groove 202, which fits around a sill 204, wherein the sill 204 is fixedly connected to the housing bottom 160. There are respective sealing strips 206 between the projections 196, 198 and the side walls 158, resulting overall in a U-shaped seal 202, 204, 206 between the housing 152 and the partition wall 166, thereby preventing flammable temperature-control medium from passing from the first chamber 168 into the second chamber 170.

If the thermal insulation 194 itself is not meant to be fluid-tight because it is formed from an open-cell synthetic foam, for example, then the side 208 of the partition wall 166 facing the first chamber 168 could be endowed with a fluid-tight foil (not shown). However, a plastic or metal plate (not shown) could also be arranged on this side 208 to provide the corresponding sealing effect. However, the foil, plastic plate or metal plate could also be situated in the interior of the partition wall 166.

Moreover, the partition wall 166 could also have a drainage duct (not shown) which leads away from a connection point (not shown) of the temperature-control media line 178 arranged in the partition wall 166 towards the second section 192 of the temperature-control media line 178, wherein the drainage duct is designed as a line. In this case, the connection point arranged in the partition wall is surrounded by a fluid-tight jacket (not shown) to which the drainage duct is connected. If this connection point were to leak, the drainage duct would prevent the passage of flammable temperature-control medium into the area of the ignition sources through the partition wall 166 because the flammable temperature-control medium would take the path with the smallest flow resistance through the drainage duct and would thus be conducted away from the ignition sources to the second section 192 of the temperature-control media line 178.

The centrifuge 150 thus also provides a secure seal against the passage of flammable temperature-control medium from the first chamber 168 into the second chamber 170. However, a separate partition wall can be omitted here because the thermal insulation, optionally reinforced by a plate or foil, forms the partition wall, meaning that the centrifuge can have a more compact and cost-effective construction.

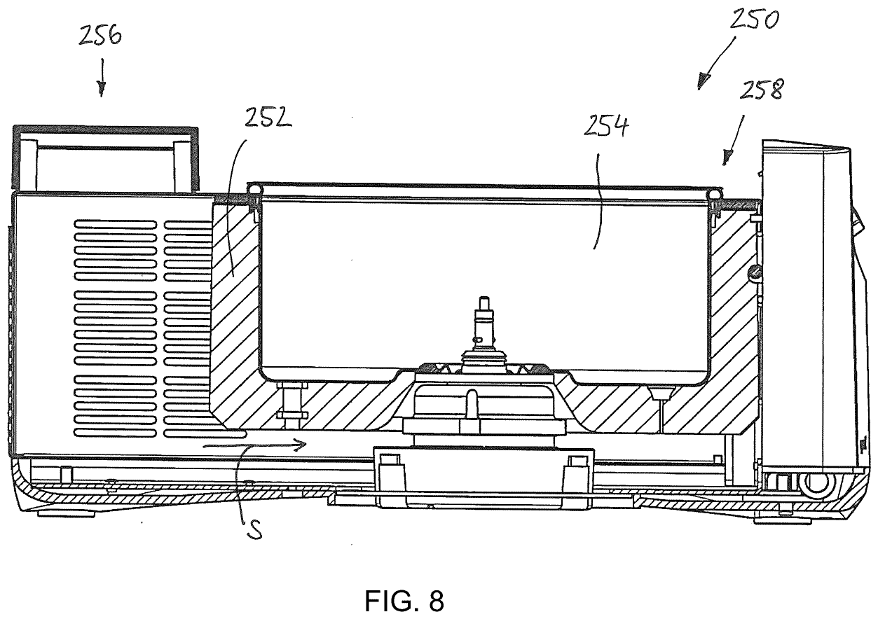

In contrast, FIG. 8 shows a centrifuge 250 according to the prior art, with the temperature-control media line not being shown for reasons of clarity.

It is apparent here that there is no fluid-tight separation next to or underneath the thermal insulation 252 of the centrifuge container 254, meaning that a released flammable temperature-control medium can flow S from the compressor side 256 to the electronics side 258, where ignition is possible.

It is clear from what has been presented above that the present disclosure provides a centrifuge 10, 150 which overcomes the disadvantages of previous centrifuges that comprise a flammable temperature-control medium. Above all, the centrifuge 10, 150 has a very simple design and nevertheless offers sufficient protection from ignition of the flammable temperature-control medium in the event of a crash, but also at standstill and during the course of operation

It should also be noted that the configurations and variants of the centrifuge described in the various embodiments and shown in the figures can be freely combined with one another. In this case, individual or multiple features can be freely exchanged. These feature combinations are likewise included in the disclosure.

### LIST OF REFERENCE DESIGNATIONS

10 first preferred embodiment of the centrifuge
12 housing
14 front panel
16 control elements
18, 18a side walls
19 rear
20 bottom
22 cover area
24 cover
26 feet
28 base area of the centrifuge 10
30 partition wall
32 first chamber
34 second chamber
36 centrifuge container
38 centrifuge motor
38a motor cover
40 first section 40 of the temperature-control media line 42
42 temperature-control media line
44 coupling
46 compressor
48 condenser
50 fan
52 second section of the temperature-control media line 42
54 section of the housing 12 that surrounds the first chamber 32
56, 57 ventilation panels, air inlets
58 ventilation panel, air outlet
60 perforations
62 perforation
64 side panel
66 box
67 perforation
68 cover area
69 screw fittings
70 lip seal
71 sealing strips
72 section of the housing 12 that surrounds the second chamber 34
74, 76 ventilation panels
78 perforations
80 first type of perforations
82 second type of perforations
84 lip seal
86 slit
88 rubber grommets
90 openings
92 safety vessel surrounding the centrifuge container 36
94 first area the first section 40 the temperature-control media line 42, evaporator
96 second area the first section 40 the temperature-control media line 42
98 connection points
150 second preferred embodiment the centrifuge
152 housing
154 front panel
156 control elements
158 side walls
160 bottom
162 feet
164 base area the centrifuge 150
166 partition wall
168 first chamber
170 second chamber
172 centrifuge container
174 centrifuge motor
176 first section the temperature-control media line 178, evaporator
178 temperature-control media line
180 coupling
182 electric and electronic elements, such as power relay, controller, circuit boards and the like
184 compressor
186 condenser
188 fan
190 injection valve
192 second section the temperature-control media line 178
194 thermal insulation
196,198 laterally projecting projections of the thermal insulation 194
200 lower carrier of the thermal insulation 194
202 groove
204 sill
206 sealing strips
208 side of the partition wall 166 facing the first chamber 168
250 centrifuge according to the prior art
252 thermal insulation
254 centrifuge container
256 compressor side
258 electronics side
S flow of a released flammable temperature-control medium

1. A centrifuge (10; 150), comprising:
a centrifuge container (36; 172) for receiving a centrifuge rotor;
a centrifuge motor (38; 174) for driving the centrifuge rotor;
a cooling system with an evaporator (94; 176) and a compressor (46; 184) for temperature-controlling the centrifuge rotor; and
a housing (12; 152) in which the centrifuge container (36; 172), the centrifuge rotor, and the cooling system are housed,
wherein the housing (12; 152) comprises a housing bottom (20; 160), a housing wall (14, 18, 18a, 19; 154, 158), and a cover (24),
wherein the cooling system includes a flammable refrigerant which is routed in a refrigerant line (42; 178),
wherein a first section (40; 176) of the refrigerant line (42; 178) is arranged in an area of potential electrical or electronic ignition sources,
wherein a second section (52; 192) of the refrigerant line (42; 178) is not arranged in the area of potential electrical or electronic ignition sources, and
wherein the first section (40; 176) does not include connection points.

2. The centrifuge (10; 150) according to claim 1,
further comprising a partition wall (30; 166) in the housing (12; 152),
wherein the first section (40; 176) of the refrigerant line (42; 178) is arranged on one side of the partition wall (30; 166) and the second section (52; 192) of the refrigerant line (42; 178) is arranged on an opposite side of the partition wall (30; 166), and
wherein the second section (52; 192) of the refrigerant line (42; 178) includes at least one connection point (98).

3. The centrifuge (10; 150) according to claim 2,
wherein the partition wall (30; 166) separates the housing (12; 152) into two chambers (32, 34; 168; 170) including a first chamber (32; 168) and a second chamber (34; 170),
wherein the first chamber (32; 168) surrounds the centrifuge container (36; 172) at least in some areas and the compressor (46; 184) is arranged in the second chamber (34; 170), and/or
wherein the first section (40; 176) of the refrigerant line (42; 178) is arranged in the first chamber (32; 168) and the second section (52; 192) of the refrigerant line (42; 178) is arranged in the second chamber (34; 170).

4. The centrifuge (10; 150) according to claim 3,
wherein the partition wall (30; 166) provides a fluid-tight separation between the two chambers (32, 34; 168, 170).

5. The centrifuge (10; 150) according to claim 3,
wherein the second chamber (34; 170) does not contain any elements (46, 50; 184, 188, 190) which can generate an ignition impulse for igniting the flammable refrigerant.

6. The centrifuge (10; 150) according to claim 3,
wherein the first chamber (32; 168) is closed except for ventilation openings (60).

7. The centrifuge (10; 150) according to claim 6,
wherein the first chamber (32; 168) is fluid-tight, and/or
wherein the first chamber (32; 168) can be sealed shut in a fluid-tight manner by the cover (24).

8. The centrifuge (10; 150) according to claim 3,
wherein in the area of the first section (40; 176) of the refrigerant line (42; 178) and/or in the area of the first chamber (32; 168), the housing (12; 152) does not have any perforations for air exchange in the housing bottom (20; 160).

9. The centrifuge (10; 150) according to claim 2,
further comprising a fluid-tight seal between the partition wall (30; 166) and the housing (12; 152),
wherein the fluid-tight seal surrounds the partition wall (30; 166) completely, and
wherein the fluid-tight seal is a lip seal (202, 204) or a sealing strip (206).

10. The centrifuge (10; 150) according to claim 2,
further comprising a feed-through (80, 82) through the partition wall (30; 166) with a fluid-tight seal,
wherein the fluid-tight seal is a rubber grommet (88), and/or a sealing contour (84), and
wherein the feed-through (80, 82) is a feed-through for cables and/or the refrigerant line (42; 178).

11. The centrifuge (10; 150) according to claim 2,
further comprising a safety vessel (92) that surrounds the centrifuge container (36) at least partially,
wherein at least a first area (94) of the refrigerant line (42) extends inside the safety vessel (92),
wherein a second area (96) of the refrigerant line (42) extends between safety vessel (92) and the partition wall (30),
wherein the first area (94) of the refrigerant line (42) and/or the second area (96) of the refrigerant line (42) is designed without connection points.

12. The centrifuge (10; 150) according to claim 11,
wherein a feed-through through the safety vessel includes a fluid-tight seal,
wherein the fluid-tight seal is a rubber grommet and/or a sealing contour, and
wherein the feed-through is configured for cables and/or the refrigerant line (42; 178).

13. The centrifuge (10; 150) according to claim 2,
wherein the partition wall (30; 166) comprises plastic and/or metal, and/or
wherein the partition wall (166) comprises a thermal insulation foam integrally connected to a thermal insulation material of the centrifuge container (172), and/or
wherein the partition wall (30; 166) comprises a fluid-tight foil, plastic plate, or metal plate.

14. The centrifuge (150) according to claim 2,
wherein the partition wall (166) has a drainage duct which leads away from a connection point of the refrigerant line (178) arranged in the partition wall (166) to the second section (192) of the refrigerant line (178),
wherein the drainage duct is a line, and
wherein the connection point arranged in the partition wall (166) is surrounded by a fluid-tight jacket to which the drainage duct is connected.

15. The centrifuge (10; 150) according to claim 1,
further comprising perforations (60) for air exchange in the housing wall (18, 18a) in the area of the first section (40; 176) of the refrigerant line (42; 178),
wherein the perforations (60) have a distance from a base area (28; 164) of the centrifuge (10; 150) of at least 2 cm, and/or
further comprising at least one perforation (60; 78) for air exchange in the housing wall (18, 18a, 19) both in the area of the first section (40; 176) of the refrigerant line (42; 178) and in the area of the second section (52; 192) of the refrigerant line (42; 178),
wherein the at least one perforation (78) in the area of the second section (52; 192) are arranged closer to the base area (28; 164) of the centrifuge (10; 150),
wherein the at least one perforation (60) in the area of the second section (52; 192) are preferably arranged at least 1 cm closer to the base area (28; 164) of the centrifuge (10; 150).

16. The centrifuge (10; 150) according to claim 1,
wherein the housing (12; 152) includes feet (26; 162) for spacing the housing bottom (20; 160) apart from a base area (28; 164) of the centrifuge (10; 150),
wherein the feet (26; 162) have a height of at least 1 cm, and
wherein the centrifuge is a laboratory centrifuge (10; 150).
